(19) United States
(12) Patent Application Publication
(10) Pub. No.: US 2026/0090586 A1
(43) Pub. Date: Apr. 2, 2026

(54) MANUFACTURING METHOD AND MANUFACTURING DEVICE FOR AEROSOL GENERATING SUBSTRATE

(71) Applicant: SMOORE INTERNATIONAL HOLDINGS LIMITED, Cayman Islands (GB)

(72) Inventors: Jun NI, Shenzhen (CN); Mingwen WEI, Shenzhen (CN); Wenfeng LI, Shenzhen (CN); Jianguo TANG, Shenzhen (CN); Xiaoxiang LIAO, Shenzhen (CN); Zutao JIN, Shenzhen (CN)

(73) Assignee: SMOORE INTERNATIONAL HOLDINGS LIMITED, Cayman Islands (GB)

(21) Appl. No.: 19/413,340

(22) Filed: Dec. 9, 2025

Related U.S. Application Data
(63) Continuation of application No. PCT/CN2023/140414, filed on Dec. 20, 2023.

(30) Foreign Application Priority Data
Jun. 9, 2023 (CN) 202310686388.4

(51) Int. Cl. A24F 40/70; A24F 40/20; F26B 19/00

(52) U.S. Cl. CPC A24F 40/70; A24F 40/20; F26B 19/00

(57) ABSTRACT

A manufacturing method for an aerosol generating substrate, which method includes: subjecting a mixed material to low-temperature extrusion to form an extruded substrate; and subjecting the extruded substrate to hot air drying. In addition, further provided is a manufacturing device for an aerosol generating substrate.

### CROSS-REFERENCE TO RELATED APPLICATION

This is a continuation of International Patent Application No. PCT/CN2023/140414 filed on Dec. 20, 2023, which claims priority to Chinese Patent Application 202310686388.4 filed on Jun. 9, 2023. The disclosures of these applications are hereby incorporated by reference in their entirety.

### BACKGROUND

An aerosol generating substrate may form an aerosol by ignition or by heating without combustion. In one kind of aerosol generating substrate that is heated without combustion, the aerosol generating substrate is heated with an external heat source so that the aerosol generating substrate is heated just enough to emit aerosol, while the aerosol generating substrate does not burn. By loading smoking agents, the aerosol is formed by heating the aerosol generating substrate to release the smoking agents when in use.

Existing manufacturing system mainly includes three methods: casting, coating and rolling. It is necessary to control the moisture and the morphology of the substrate by hot air drying, and it is necessary to prepare a cylindrical aerosol generating substrate by a gathering or filling device. The related method and manufacturing system have a long process, a large circulation of intermediate products from raw materials to finished products, a large investment in the manufacturing system, and easy loss of effective substances in the manufacturing process.

### SUMMARY

The present disclosure relates to the technical field of an aerosol generating substrate, in particular to method and apparatus for manufacturing an aerosol generating substrate.

In order to achieve the above objects, an embodiment of the present disclosure provides a method for manufacturing an aerosol generating substrate, comprising the following operations.

A material mixture is subject to low temperature extrusion to form an extrusion substrate.

The extrusion substrate is subjected to hot air drying.

Embodiments of the present disclosure also provide an apparatus for manufacturing an aerosol generating substrate, and the manufacturing apparatus comprises an extrusion device and a drying device.

The extrusion device is configured for subjecting a material mixture to low temperature extrusion to form an extrusion substrate.

The drying device is configured for subjecting the extrusion substrate to hot air drying.

### BRIEF DESCRIPTION OF THE DRAWINGS

FIG. 1 is a flow block diagram of a manufacturing method according to an embodiment of the present disclosure;

FIG. 2 is a schematic structural diagram of a manufacturing system according to an embodiment of the present disclosure, in which an extrusion object is extruded vertically;

FIG. 3 is a schematic cross-sectional view of the structure shown in FIG. 2;

FIG. 4 is a schematic structural diagram of a manufacturing system according to another embodiment of the present disclosure, in which an extrusion object is extruded in a horizontal direction;

FIG. 5 is a schematic structural diagram of a flow guide channel and a conveyor belt according to an embodiment of the present disclosure;

FIG. 6 is an enlarged schematic view of the portion A in FIG. 5;

FIG. 7 is a schematic structural diagram of a die opening according to an embodiment of the present disclosure;

FIG. 8 is a schematic structural diagram of the die opening shown in FIG. 7 and an extrusion substrate;

FIG. 9 is a schematic structural diagram of a die opening and a die base in an embodiment of the present disclosure;

FIG. 10 is a schematic structural diagram of an adapter, a die opening, and a die base according to an embodiment of the present disclosure;

FIG. 11 is a schematic structural diagram of a hardening device according to an embodiment of the present disclosure; and

FIG. 12 is a schematic structural diagram of a hardening device according to another embodiment of the present disclosure.

### DETAILED DESCRIPTION

It should be noted that embodiments in the present disclosure and technical features in the embodiments can be combined with each other in the absence of conflicts, and the detailed description of the embodiments should be understood as an explanation of the purpose of the present disclosure, and should not be regarded as an undue limitation of the present disclosure.

In the present disclosure, the temperature unit “C” means degrees Celsius. The pressure unit is “bar”. The unit “μm” means micron. The viscosity unit “pa·s” means Pascal·Second. The unit “pa” means Pascal.

The aerosol generating substrate is intended for generating an aerosol by heating. By way of example, the aerosol generating substrate may be adapted to generate an aerosol in a manner of heating and combustion. The aerosol generating substrate may also be adapted to generate an aerosol in a manner of heating without combustion. That is to say, the aerosol generating substrate is heated to a temperature below an ignition point to generate an aerosol.

The aerosol generating substrate does not burn during the process of generating the aerosol. The aerosol generating substrate provided by embodiments of the present disclosure is used for an aerosol generating article. The aerosol generating article includes the aerosol generating substrate and a functional segment. The functional segment is disposed at an end of the aerosol generating substrate along a longitudinal direction, and the functional segment comprises a filtering segment for filtering the aerosol. The filtering segment is configured to filter the aerosol generated by the aerosol generating substrate.

The aerosol generating article is used for a user to suck the aerosol generated by the aerosol generating substrate. For example, the user may suck the filtered aerosol by holding the filtering segment in the mouth. The aerosol generated from the aerosol generating substrate is delivered to the filtering segment under the negative pressure caused by sucking.

The aerosol generating article is used in conjunction with an aerosol generating device having a heating assembly. Specifically, the heating assembly heats and atomizes the aerosol generating substrate to produce the aerosol.

The heating assembly performs heating by a variety of heating ways. By way of example, the heating ways include central heating, peripheral heating, and/or bottom heating. The central heating means that the heating assembly is inserted into the inside of the aerosol generating article to bake and heat the aerosol generating article from inside to outside. The peripheral heating means that the heating assembly is disposed at the periphery of the aerosol generating article to bake and heat the aerosol generating article from outside to inside. The bottom heating means that the heating assembly is located at the bottom of the aerosol generating article, and the heating assembly heats the air first, then the hot air bakes and heats the aerosol generating article from bottom to top.

It should be noted that the bottom of the aerosol generating article is an end of the aerosol generating article that is far away from the functional segment in a longitudinal direction.

The heating mode of the heating assembly includes, but is not limited to, resistance heating, electromagnetic heating, infrared heating, microwave heating, or laser heating.

In some embodiments, the functional segment may be provided with only a filtering segment.

In other embodiments, the functional segment further comprises a cooling segment located between the filtering segment and the aerosol generating substrate, and the cooling segment is used to cool the aerosol before the filtering segment filters the aerosol. The cooling segment can improve the phenomenon of “burning mouth” when the user sucks the aerosol.

Cooling materials used in the cooling segment include, but are not limited to, one or a combination of some of PE (polyethylene), PLA (Polylactic Acid), PBAT (Polybutylene Adipate Terephthalate), PP (Polypropylene), acetate fiber, propylene fiber and the like.

Filtering materials used in the filtering segment include, but are not limited to, one or a combination of some of PE (polyethylene), PLA (Polylactic Acid), PBAT (Polybutylene Adipate Terephthalate), PP (Polypropylene), acetate fiber, propylene fiber, and the like.

The material of the cooling segment and the material of the filtering segment may be the same or different.

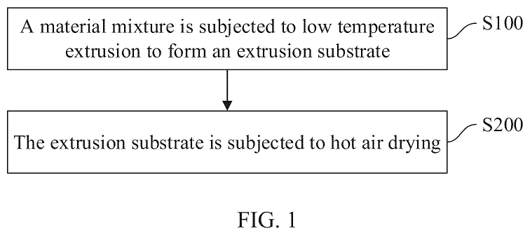

Referring to FIG. 1, an embodiment of the present disclosure provides a method for manufacturing an aerosol generating substrate, and the manufacturing method includes the following operations.
S100: a material mixture is subjected to low temperature extrusion to form an extrusion substrate.

The material mixture is constituent component of the aerosol generating substrate. The low temperature extrusion shapes the material mixture to obtain an extrusion substrate 1000 having the same cross-sectional shape as the aerosol generating substrate. That is, the cross-sectional shape of the extrusion substrate 1000 is the same as the cross-sectional shape of the aerosol generating substrate. The extrusion process is used to shape the material mixture without changing the chemical properties of the material mixture.

It should be noted that the longitudinal direction refers to the extending direction of the aerosol generating substrate. For example, the aerosol generating substrate is achieved by extrusion molding, and the longitudinal direction is the extending direction of the extrusion substrate 1000. The cross-sectional shape refers to the shape presented by the extrusion substrate 1000 with a plane perpendicular to the longitudinal direction as the cross section.

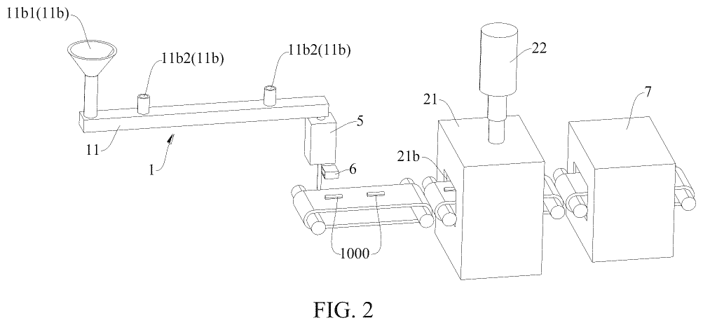

Referring to FIGS. 2 to 4, the extrusion molding refers to a processing method in which the material mixture is pushed forward by an extrusion screw 12 through the action between a barrel of the extrusion device 1 and the extrusion screw 12, and is formed into extrusion substrates 1000 having various cross-sectional shapes through die openings 13 at a discharge port 11c.

Low temperature extrusion refers to that an extrusion temperature is below 10° C.

It should be noted that, in the field of extrusion, when the extrusion temperature is 90° C. or higher, the extrusion is considered as high temperature extrusion. When the extrusion temperature ranges from 10° C. to 90° C. (including 10° C. and 90° C.), the extrusion is considered as normal temperature extrusion. The extrusion temperature is the temperature within the extrusion cavity of the extrusion device.

During the extrusion molding process, the temperature may affect parameters such as the retention rate of volatile aroma substances of the extrusion substrate 1000 and the viscosity of the material mixture. Low temperature extrusion molding can offset the heat generated by mutual friction and pressure of the material mixture during the extrusion process, thus reducing the loss of volatile aroma substances in the extrusion molding process. The corresponding relationship between the temperature and the retention rate of volatile aroma is shown in Table 1.

According to Table 1, the higher the temperature, the lower the retention rate of volatile aroma substances in the material mixture; the lower the temperature, the higher the retention rate of volatile aroma substances in the material mixture. Among them, when the extrusion temperature is −10° C., the retention rate of volatile aroma substances in the material mixture is as high as 95%; when the extrusion temperature is 10° C., the retention rate of volatile aroma substances in the material mixture is 85%; and when the extrusion temperature is 60° C., the retention rate of volatile aroma substances in the material mixture is only 50%. It can be seen that when the extrusion temperature in the low temperature extrusion molding is from −10° C. to 10° C., the retention rate of volatile aroma substances in the material mixture is high, which can meet the demand and ensure the quality of extruded substance 1000.

TABLE 1

| Serial number | Temperature (° C.) | Retention rate |
|---|---|---|
| 1 | −10 | 95% |
| 2 | −5 | 93% |
| 3 | 0 | 90% |
| 4 | 10 | 85% |
| 5 | 15 | 80% |
| 6 | 25 | 78% |
| 7 | 40 | 67% |
| 8 | 50 | 58% |
| 9 | 60 | 50% |

Temperature has a great influence on the viscosity of the material mixture, and the viscosity of the material mixture also has an influence on the extrusion pressure. The corresponding relationship between the temperature and the rheological property of slurry is shown in Table 2.

TABLE 2
Corresponding relationship between the temperature and the
rheological property of slurry

| | Temperature of the | Viscosity of the |
|---|---|---|
| Serial | material mixture | material mixture |
| number | (° C.) | (Pa · s) |
| 1 | −10 | 3200 |
| 2 | −5 | 2825 |
| 3 | 0 | 2450 |
| 4 | 10 | 2300 |
| 5 | 15 | 1950 |
| 6 | 25 | 1400 |
| 7 | 30 | 1200 |

As can be seen from Table 2, as the temperature increases, the viscosity of the material mixture decreases, and when the extrusion temperature is higher than or equal to 10° C., the bonding force between mixed materials is small, and thus the extrusion substrate 1000 is easy to loosen or crack, which leads to a decrease in yield.

When the extrusion temperature is lower than 10° C., the viscoelasticity of the mixed slurry increases, and the extrusion substrate 1000 is more easily bonded tightly, and the problems of loosening and cracking are less likely to occur.

By way of example, the extrusion temperature for the low temperature extrusion is not less than −50° C. (i.e., greater than or equal to −50° C.) and less than 10° C. For example, the extrusion temperature for the low temperature extrusion is −50° C., −30° C., −20° C., −10° C., −9° C., −8° C., −7° C., −6° C., −5° C., 0° C., 0.5° C., 1° C., 3° C., 5° C., 8° C., 9° C. or 9.5° C.

More preferably, the extrusion temperature for the low temperature extrusion may be from −35° C. to 5° C. (including −35° C. and 5° C.).

When the extrusion temperature ranges from −35° C. to 5° C., the extrusion pressure can be at an equilibrium point, and the extrusion substrate 1000 that is extruded is morphologically uniform and structurally stable.

In one embodiment, the extrusion pressure for the low temperature extrusion ranges from 0.5 bar to 300 bar. By way of example, the extrusion pressure for the low temperature extrusion is 0.5 bar, 10 bar, 30 bar, 50 bar, 60 bar, 65 bar, 70 bar, 80 bar, 85 bar, 90 bar, 95 bar, 100 bar, 105 bar, 150 bar, 200 bar, or 300 bar.

The extrusion pressure described in the embodiments of the present disclosure refers to the extrusion pressure of an extrusion die (e.g. a die opening) located at the discharge port of the extrusion device.

The extrusion pressure has an effect on the shape, surface smoothness, yield, and production rate of the aerosol generating substrate. In the low temperature extrusion process, when the extrusion pressure is lower than 0.5 bar, the molding rate of the aerosol generating substrate is low, and the product defect rate is increased, which in turn leads to the slowdown of the production rate and the increase of the production cost. When the extrusion pressure is higher than 300 bar, the transmission structure of the extrusion device 1 has a high load (the torque required to be provided is high), which leads to the reduction of the service life of the extrusion device 1. Therefore, by controlling the extrusion pressure in the range of 0.5 bar to 300 bar, the molding rate of the aerosol generating substrate can be improved, and the service life of the extrusion device 1 can be extended.

More preferably, the extrusion pressure for the low temperature extrusion is from 30 bar to 150 bar (including 30 bar and 150 bar).
S200: The extrusion substrate is subjected to hot air drying.

If the aerosol generating substrate contains an excess amount of liquid, such as moisture, the aerosol generating substrate is not easy to be stored and transported, is susceptible to deformation under force, and is also susceptible to “burning mouth” during heating of the aerosol generating substrate. Accordingly, the extrusion substrate 1000 contains more solvents, such as moisture, and/or other volatile lubricants, and the solvents and/or lubricants need to be removed to obtain a dry aerosol generating substrate for use or storage.

Hot air drying refers to drying the extrusion substrate 1000 with a hot air flow. The hot air flow may be in contact with the extrusion substrate 1000 to transfer heat to the extrusion substrate 1000 such that the solvent and/or the lubricant within the extrusion substrate 1000 is evaporated or sublimated, thereby reducing the solvent content and/or the lubricant content in the extrusion substrate 1000 to achieve the purpose of drying the extrusion substrate 1000.

In the manufacturing method provided by an embodiment of the present disclosure, the material mixture is subject to the low temperature extrusion, since the viscosity of the material mixture is high, the extrusion substrate 1000 is more easily bonded tightly, the problems of loosening and cracking are not easy to occur, and the yield rate is effectively improved. In addition, the low temperature extrusion can offset the heat generated during the extrusion process of the material mixture, thereby reducing the loss of volatile aroma substances during the extrusion process. The hot air drying enables batch drying of the extrusion substrate 1000 at a fast drying speed, and the moisture content of the extrusion substrate 1000 is reduced by the hot air drying, so as to facilitate storage and use of the aerosol generating substrate. The aerosol generating substrate obtained by the low temperature extrusion and the hot air drying is a one-piece formed structure. In this way, during use of the aerosol generating substrate, for example, after being heated and sucked or after being stopped being heated, the aerosol generating substrate is an integrated medium, and the problem of disintegration and falling is not easy to occur.

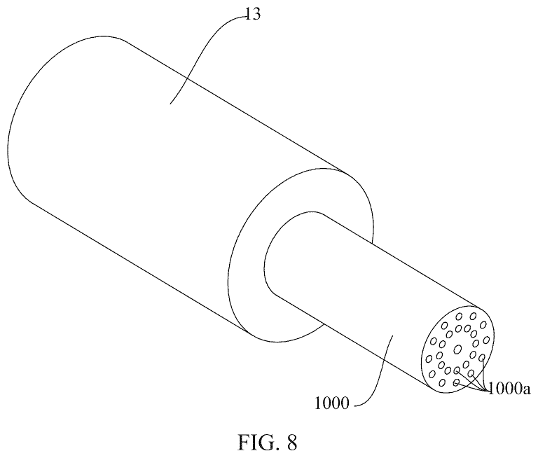

By way of example, in one embodiment, referring to FIG. 8, the aerosol generating substrate is formed with airways 1000a extending through at least one end of the aerosol generating substrate in the longitudinal direction. For example, the airways 1000a extend through an end of the aerosol generating substrate in the longitudinal direction. As another example, the airways 1000a extend through both ends of the aerosol generating substrate in the longitudinal direction. The airflow may flow longitudinally from one end of the aerosol generating substrate to another end of the aerosol generating substrate. In this way, the gas flow formed by the aerosol and carried by the air can flow more smoothly, and the gas flow resistance is smaller, which can significantly reduce the sucking resistance during the sucking process and improve the sucking experience.

In one embodiment, the airways 1000a may be formed inside the aerosol generating substrate or on an outer circumferential surface of the aerosol generating substrate.

In one embodiment, the airway 1000a is a linear airway 1000a extending along a straight line. The linear airway 1000a is easy to mold, and the manufacturing difficulty can be reduced. The flow resistance of the airflow within the linear airway 1000a is relatively small.

In one embodiment, the airway 1000a is a curved airway 1000a, and at least some of hole segments of the curved airway 1000a are curved with non-zero curvature. The curved airway 1000a can increase the flow path of the airflow to a large extent without significantly increasing the length of the aerosol generating substrate, and can prolong the contact time of the airflow with the hole wall surface of the curved airway 1000a, thereby improving the aerosol extraction rate.

In one embodiment, the curved airway 1000a is a spiral line in shape. That is, the three-dimensional shape of the curved airway 1000a is a spatial spiral line shape. For example, in the extrusion process, the curved airway 1000a of the extrusion substrate 1000 may be formed by rotating the die opening. A line connecting an arbitrary point of the spiral curved airway 1000a to the starting point has an inclination angle with respect to the axis thereof. The spiral curved airway 1000a can greatly prolong the flow path of the airflow, and in the case where the aerosol precipitates from the aerosol-generating substrate into the curved airway 1000a, can increase the flow speed of the aerosol in the aerosol generating substrate, thereby improving the impact force of the airflow, allowing the aerosol to be uniformly mixed, improving the uniformity of the aerosol, and improving the smoking feeling of the user.

It should be understood that the extrusion substrate 1000 is a semi-finished product of the aerosol generating substrate, the extrusion substrate 1000 has the same morphology as the aerosol generating substrate, and in the case of the aerosol generating substrate having airways 1000a, the extrusion substrate 1000 also has the same airways 1000a.

The cross-sectional shape of the airway 1000a located inside the aerosol generating substrate is not limited, for example, the cross-sectional shape may be a circular shape, a polygonal shape (including but not limited to triangle, square, rhombus, etc.), an elliptical shape, a running track shape, or a special shape, herein the special shape refers to other symmetrical or non-symmetrical shapes other than the shapes listed above.

The cross-sectional shape of the airway 1000a located on the outer circumferential surface of the aerosol generating substrate may be a semicircular shape, a semi-elliptical shape, a polygonal shape, or a special shape, herein the special shape refers to other symmetrical or asymmetrical shapes other than the shapes listed above.

The number of airways 1000a is not limited, and there is one airway or there are a plurality of airways 1000a. The term “a plurality of” refers to the number including two or more.

It should be noted that micropores exist inside the aerosol generating substrate, for example, for the aerosol generating substrate of the particle combination, gaps between the particles constitute micropores. However, the airway 1000a described herein is different from the micropore. The airway 1000a described herein is a hole in a macroscopic sense, the micropore is a pore in a microscopic sense, and the dimensions such as a cross-sectional area and a length of the airway 1000a are much larger than that of the micropore. Since the airway 1000a is mainly processed by, for example, the die opening, dimensions such as the cross-sectional area and length of the airway 1000a can be changed according to the design requirements, and the dimension of the micropore is determined by the gap between the particles. For example, if the material mixture is granular materials, the extrusion object formed by extrusion molding from the material mixture has micropores, and dimensions such as the cross-sectional area and length of the micropores are difficult to be significantly changed by processing.

In one embodiment, the operation that the material mixture is subject to a low temperature extrusion to form an extrusion substrate comprises the following operation.

The material mixture is subjected to the low temperature extrusion through an extrusion device to form the extrusion substrate.

In one embodiment, the operation that the material mixture is subjected to the low temperature extrusion through the extrusion device to form the extrusion substrate, comprises the following operation.
S101: a plurality of raw materials are mixed into the material mixture.
S102: the material mixture is added into the extrusion device.

In this embodiment, a plurality of raw materials such as plant raw materials, auxiliary raw materials and smoking agent raw materials are mixed in advance to form a material mixture, and then the material mixture is added into the extrusion device 1 for extrusion molding. That is, a slurry feeding mode is adopted, and the advantage of the slurry feeding mode is that the materials have good consistency and uniformity and stability of the product can be ensured.

In one embodiment, the operation that the material mixture is subjected to the low temperature extrusion through the extrusion device to form the extrusion substrate, comprises the following operation
S103: A plurality of raw materials are respectively added into a plurality of feed ports of the extrusion device to form the material mixture in the extrusion device.

In this embodiment, a plurality of raw materials such as plant raw materials, auxiliary raw materials, and smoking agent raw materials are fed into the extrusion device 1 in modules, and the plurality of raw materials are mixed in the extrusion device 1. That is, the modular feeding mode is adopted.

By way of example, referring to FIGS. 2 to 4, one of the plurality of feed ports 11b is a solid material feed port 11b1 for adding solid material, and one of the plurality of feed ports 11b is a liquid material feed port 11b2 for adding liquid material, the liquid material feed port 11b2 being located downstream of the solid material feed port 11b1 in the material flow direction. When feeding, the solid material is first added through the solid material feed port 11b1, and the liquid material is added when the solid material reaches the liquid material feed port 11b2. In addition, the feeding amount and the feeding speed can also be determined according to the production speed of the apparatus and the proportion of material formula. The advantage of this modular feeding mode is that the cost of material pretreatment can be reduced, the continuity of the production process can be ensured, and the production efficiency of the product can be improved.

In some embodiments, referring to FIGS. 2 to 4, the extrusion device 1 comprises a feed screw 14 rotatably disposed in the feed port 11b. The feed screw 14 can further homogenize the raw materials, and can better ensure continuous and stable feeding of the raw materials.

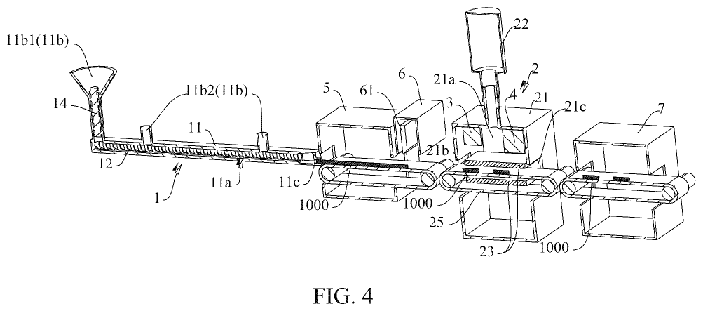

In one embodiment, referring to FIG. 4, the extrusion substrate 1000 is extruded in a horizontal direction. For example, the discharge port 11c is arranged in the horizontal direction, and the die opening 13 may be provided in the horizontal direction. For example, for an extrusion substrate 1000 having curved, e.g., spiral, airways 1000a, the extrusion substrate 1000 is extruded in the horizontal direction and can, by rotating the die opening, directly enter the next device, e.g., the hardening device 5. The extrusion substrate 1000 can be stressed by the rotation of the die opening, while horizontal extrusion can reduce the direct release of the stress generated by the extrusion substrate 1000 (the generated stress can be eliminated by heating), thereby improving the yield of the aerosol generating substrate having the spiral airways 1000a.

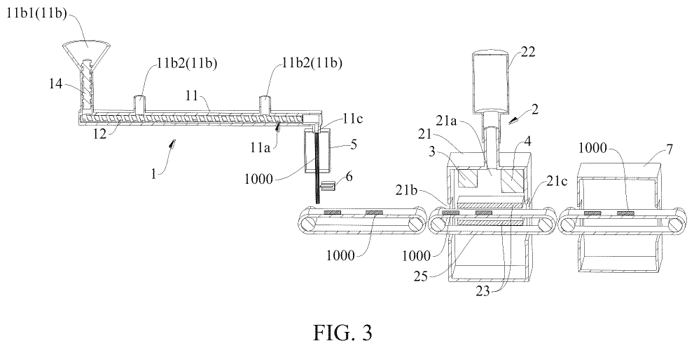

In one embodiment, referring to FIGS. 2 and 3, the extrusion substrate 1000 is extruded in a vertical direction. For example, the discharge port 11c faces downward, and the die opening 13 may be disposed in the vertical direction. That is, the extrusion substrate 1000 is extruded in the direction of gravity. By way of example, for the extrusion substrate 1000 having the linear airways 1000a, the extrusion substrate 1000 is extruded in the vertical direction, which can improve the yield, reduce the input cost of the extrusion device 1, and further reduce the occupied area of the extrusion device 1.

In one embodiment, the extrusion substrate 1000 is extruded in an inclined direction. The inclined direction means that an angle between the extrusion direction of the extrusion substrate 1000 and the horizontal plane is greater than 0° and less than 90°. The inclined extrusion not only reduces the extrusion pressure of the material mixture, but also facilitates the space design of other devices, such as the drying device 2.

In one embodiment, the material mixture comprises, in parts by weight, 30 to 90 parts of plant raw materials, 1 to 15 parts of auxiliary raw materials, 5 to 30 parts of smoking agent raw materials, 1 to 10 parts of binder raw materials, and 1 to 15 parts of perfume raw materials. Specifically, the total weight parts of the plant raw materials, the auxiliary raw materials, the smoking agent raw materials, the binder raw materials, and the perfume raw materials are 100 parts.

The plant raw material is used to generate aerosols when being heated. The auxiliary raw material is used to provide skeleton support for the plant material. The smoking agent raw material is used to produce smoke when being heated. The binder raw material is used to bind the component material. The perfume raw material provides a characteristic aroma. In this way, the plant raw material and the smoking agent raw material can ensure the amount of aerosol generated, while the perfume raw material can improve the release of aroma during sucking and improve user experience. The auxiliary raw material can not only improve the fluidity of the material mixture, but also make the aerosol generating substrate have a porous structure, so as to facilitate the extraction and flow of the aerosol. The binder raw material ensures that the plant raw material powder and the auxiliary agent form a stable mixture, to avoid a loose structure.

In one embodiment, the plant raw materials are particles formed after crushing of one or a combination of some of tobacco leaf raw materials, tobacco leaf fragments, tobacco stalks, tobacco powders, flavored plants and the like. Plant raw materials are the core source of fragrance, and endogenous substances in plant raw materials can give users physiological satisfaction. Endogenous substances such as alkaloids enter the human blood and promote the pituitary gland to produce dopamine, thus obtaining physiological satisfaction.

In one embodiment, the auxiliary raw material may be one or a combination of some of an inorganic filler, a lubricant, and an emulsifier. The inorganic filler includes one of or a combination of some of heavy calcium carbonate, light calcium carbonate, zeolite, attapulgite, talc, and diatomaceous earth. The inorganic filler can provide skeleton support for the plant raw material, and the inorganic filler also have micropores, which can improve the porosity of the aerosol generating substrate, thereby increasing the release rate of the aerosol.

The lubricant may include one of or a combination of some of candelilla wax, carnauba wax, shellac, sunflower wax, rice bran, beeswax, stearic acid, and palmitic acid. The lubricant can increase the fluidity of the plant raw material powder, reduce the friction between the plant raw material powders, make the overall density of the plant raw material powder distribution more uniform, reduce the pressure required in the extrusion molding process, and reduce the wear of the die opening 13.

The emulsifier may include one of or a combination of some of polyglycerol fatty acid esters, Tween-80, and polyvinyl alcohol. To a certain extent, the emulsifier can slow down the loss of aroma substances during storage, increase the stability of aroma substances and improve the sensory quality of products.

In one embodiment, the smoking agent raw material may comprise: one of or a combination of some of a monohydric alcohol (such as menthol); polyols (such as propylene glycol, glycerol, triethylene glycol, 1,3-butanediol and tetraethylene glycol); esters of polyols (such as glyceryl triacetate, triethyl citrate, glyceryl diacetate mixture, triethyl citrate, benzyl benzoate, glycerin tributyrate); monocarboxylic acids; dicarboxylic acids; polycarboxylic acids (such as lauric acid, myristic acid) or aliphatic esters of polycarboxylic acids (such as dimethyl dodecanedioate, dimethyl tetradecanedioate, erythritol, 1, 3-butanediol, tetraethylene glycol, triethyl citrate, propylene carbonate, ethyl laurate, Triactin, meso-erythritol, glyceryl diacetate mixture, diethyl suberate, triethyl citrate, benzyl benzoate, benzyl phenylacetate, ethyl vanilate, glyceryl tributyrate, lauryl acetate).

In one embodiment, the binder raw material is in close contact with the component raw material by interface wetting to generate an intermolecular attraction force, thereby playing a role of bonding the component raw material such as a powder, a liquid, or the like. The binder raw material may be non-ionized modified viscous polysaccharides extracted from natural plants, including one of or a combination of some of tamarind polysaccharides, guar gum, and modified cellulose (such as carboxymethyl cellulose). The binder is used to bond the particles together, thereby making them not easy to loosen. In addition, this improves the water resistance of the aerosol generating substrate and is harmless to the human body.

In one embodiment, the perfume raw material is used to provide a characteristic aroma, such as a dry hay aroma, a roasted sweet aroma, or solid or liquid substances of nicotine. The perfume raw material may include one of or a combination of some of tobacco, aroma plant extracts, extractums, essential oils, and neat oils. The perfume raw material may include a monomeric aroma substance, for example, one of or a combination of some of megastigmatrienone, neophytadiene, geraniol, and nerole.

By way of example, in one embodiment, the temperature for hot air drying ranges from 50° C. to 200° C. For example, the temperature for hot air drying is 50° C., 60° C., 61° C., 63° C., 65° C., 70° C., 72° C., 74° C., 85° C., 90° C., 95° C., 100° C., 128° C., 130° C., 135° C., 140° C., 145° C., 150° C., or 200° C. When the temperature for hot air drying is less than 50° C., the drying time is long, the production efficiency is low, the drying device 2 occupies a large area, and the equipment cost is high. When the temperature for hot air drying is greater than 200° C., the moisture on the surface of the extrusion substrate 1000 evaporates rapidly, while the moisture inside the extrusion substrate 1000 evaporates slowly, resulting in rapid shrinkage of the outer surface of the extrusion substrate 1000, which is not conducive to the uniformity and stability of the morphology and components of the extrusion substrate 1000. Further, the aroma components and active components such as plant alkaloids and/or smoking agents in the material mixture are easily lost by heat, so that the manufacturing cost is high, the quality of the finished aerosol generating substrate is reduced, and the user experience is reduced.

By way of example, in one embodiment, the temperature for hot air drying ranges from 75° C. to 125° C. For example, the temperature for hot air drying is 75° C., 76° C., 80° C., 81° C., 82° C., 83° C., 86° C., 91° C., 94° C., 96° C., 98° C., 99° C., 101° C., 105° C., 106° C., 110° C., 120° C., or 125° C. When the hot air drying adopts the above temperature, the extrusion substrate 1000 can be dried slowly. Under the condition of ensuring high drying efficiency, the evaporation speed of the liquid inside the extrusion substrate 1000 tends to be consistent with the evaporation speed of the liquid on the outer surface of the extrusion substrate 1000, thus reducing the probability that the morphology of the extrusion substrate 1000 changes with the hot air drying, and the aroma components and effective components such as plant alkaloids and/or smoking agents in the material mixture are not easily lost by heat, so that effective substances can be retained as much as possible to ensure the quality of the finished aerosol generating substrate.

In one embodiment, the moisture content of the extrusion substrate 1000 after being dried ranges from 3% to 20%. Preferably, the moisture content of the extrusion substrate 1000 after being dried ranges from 4% to 13%. By way of example, the moisture content of the extrusion substrate 1000 after being dried is 3%, 4%, 5%, 10%, 11%, 13%, 15%, 16%, 18%, or 20%. When the moisture content of the extrusion substrate 1000 after being dried is less than 3%, not only the dried extrusion substrate 1000 is fragile in the subsequent production and processing, resulting in a high subsequent production defect rate of the dried extrusion substrate 1000, thereby increasing the production cost; but also during the heating and sucking process, the impurities generated by the aerosol generating substrate are high, which affects the sucking experience. When the moisture content of the dried extrusion substrate 1000 is greater than 20%, the moisture content of the aerosol in the dried extrusion substrate 1000 is high during the heating and sucking process, and the phenomenon of “burning mouth” is easy to occur during the sucking process, thus reducing the sucking experience.

In one embodiment, the extrusion substrate 1000 has airways 1000a through at least one end thereof in the longitudinal direction, and the flow direction of the hot air is parallel to the longitudinal direction of the extrusion substrate 1000 during the hot air drying process. The hot air can not only contact the outer circumferential surface of the extrusion substrate 1000, but also enter the airways 1000a, so that the contact area between the hot air and the extrusion substrate 1000 can be increased, to improve the drying efficiency.

In one embodiment, after the material mixture is subject to the low temperature extrusion to form the extrusion substrate, the manufacturing method comprises the following operation.
S300: The extrusion substrate is cut.

Referring to FIGS. 2 and 3, the extrusion substrate 1000 may be cut by a cutting tool 61 of a cutting device 6 such that the extrusion substrate 1000 reaches a set length. In this way, the extrusion substrate 1000 of the set length can be adapted to a subsequent drying device 2 or wrapping device 7, reducing the requirements for the subsequent device.

It is understood that the specific numerical value of the set length is not limited, and the set length can be set according to the condition of the aerosol generating substrate or according to the condition of the manufacturing apparatus.

In some embodiments, the extrusion substrate 1000 subjected to the low temperature extrusion is of a continuous structure. That is, during the extrusion process, the extrusion substrate 1000 is continuously extruded such that the extrusion substrate 1000 has a continuous structure. Continuous extrusion allows improved extrusion efficiency, followed by cutting the extrusion substrate 1000 to the set length to shorten the substrate.

In some embodiments, the extrusion substrate 1000 is in a segmented configuration of a preset length. That is, during the extrusion process, when the extrusion substrate 1000 reaches the preset length, it will naturally disconnect. For example, when the extrusion substrate 1000 reaches the preset length, it leaves the die opening 13 due to itself reaching a critical value. In this way, the preset length of the extrusion substrate 1000 may be the length of the aerosol generating substrate. The extrusion substrate 1000 may also not be cut, so that the cutting device 6 can be saved and the equipment cost can be reduced.

It should be understood that the preset length may be greater than, less than or equal to the set length.

It should be noted that, in some embodiments, S300 may be performed before S200, that is, the extrusion substrate 1000 may be cut before hot air drying the extrusion substrate 1000. In some embodiments, S300 may be performed after S200, that is, the extrusion substrate 1000 may be cut after hot air drying the extrusion substrate 1000.

By way of example, in one embodiment, the manufacturing method includes: S500 of shape correction of the extrusion substrate. The shape correction refers to a circumference correction and/or a straightness correction of the extrusion substrate 1000 by a jig. The straightness refers to the degree of bending in the longitudinal direction of the extrusion substrate 1000.

Since the texture of the extrusion substrate 1000 produced by extrusion is generally relatively soft, the circumference of the extrusion substrate 1000 may be deformed and/or the extrusion substrate 1000 may be bent in the longitudinal direction, during the manufacturing of the extrusion substrate 1000, for example, during the cutting of the extrusion substrate 1000 by the cutting device 6. Thus, the circumference and/or straightness of the extrusion substrate 1000 may be corrected by the jig.

It is noted that, S500 may be performed in any case where shape correction is desired after S100, and S500 may be performed one or more times during the entire manufacturing process of the aerosol generating substrate. For example, S500 may be performed before and/or after S300. As another example, S500 may be performed before S200.

In one embodiment, before subjecting the extrusion substrate to hot air drying, the manufacturing method comprises the following operation.
S400: The extrusion substrate is hardened by cooling.

Referring to FIGS. 2 to 4, the extrusion substrate 1000 is cooled and hardened by the hardening device 5. Since the material mixture is a solid-liquid mixture, the hardness of the extrusion substrate 1000 after low temperature extrusion is low, which makes the extrusion substrate 1000 after low temperature extrusion easily deformed, and thus it is difficult to maintain the morphology of the extrusion substrate 1000. In order to improve the stability of the morphology of the extrusion substrate 1000 and facilitate the subsequent production process, the extrusion substrate 1000 is cooled and hardened to improve its hardness.

In some embodiments, the hardness of the extrusion substrate 1000 before hardening ranges from 0 HB to 100 HB (including 0 HB and 100 HB), which makes the extrusion substrate 1000 before hardening soft and easily deformable.

In one embodiment, the hardness of the hardened extrusion substrate 1000 ranges from 1 HB to 200 HB. By way of example, the hardness of the hardened extrusion substrate 1000 is 1 HB, 10 HB, 20 HB, 30 HB, 40 HB, 50 HB, 80 HB, 100 HB, 150 HB or 200 HB. In this hardness range, the morphology of the hardened extrusion substrate 1000 can be well maintained, to prevent the outer surface of the hardened extrusion substrate 1000 from adhering to other structures. The hardened extrusion substrate 1000 can be easily cut, and the cut extrusion substrate 1000 is less likely to be deformed, and the end face formed by cutting is neat and complete.

More preferably, the hardness of the extrusion substrate 1000 before cooling and hardening may be from 1 HB to 60 HB (including 1 HB and 60 HB). The hardness of the extrusion substrate 1000 after cooling and hardening may be from 40 HB to 120 HB (including 40 HB and 120 HB), and the hardness of the extrusion substrate 1000 after hot air drying may be from 40 HB to 300 HB (including 40 HB and 300 HB). Preferably, the hardness of the extrusion substrate 1000 after hot air drying may be from 80 HB to 250 HB (including 80 HB and 250 HB).

It is noted that HB is Brinell hardness.

In some embodiments, hardening the extrusion substrate by cooling comprises placing the extrusion substrate at a cooling ambient temperature for cooling and hardening, the cooling ambient temperature being lower than the hardening temperature of the extrusion substrate.

By way of example, if the hardening temperature of the extrusion substrate is from −100° C. to 10° C. (including −100° C. and 10° C.), the cooling ambient temperature may be from −270° C. to 10° C. (including −270° C. and 10° C.), provided that the cooling ambient temperature is lower than the hardening temperature of the extrusion substrate.

More preferably, if the hardening temperature of the extrusion substrate 1000 is from −30° C. to 5° C. (including −30° C. and 5° C.), the cooling ambient temperature may be from −50° C. to 5° C. (including −50° C. and 5° C.).

In one embodiment, the temperature of the extrusion substrate 1000 before hardening ranges from 0° C. to 40° C., and the temperature of the extrusion substrate 1000 after hardening ranges from −50° C. to 5° C. By way of example, the temperature of the extrusion substrate 1000 after hardening is −50° C., −45° C., −40° C., −39° C., −35° C., −30° C., −25° C., −20° C., −15° C., −10° C., −5° C., 0° C., 1° C., 3° C., or 5° C.

The manufacturing method of the present disclosure is shown below by way of several specific embodiments, and is specifically described as follows.

In a first embodiment, the aerosol generating substrate is obtained by S100, S400, S300, and S200 in order. In this embodiment, extrusion molding is achieved by S100, and the extrusion substrate 1000 is hardened by S400, the hardness of the extrusion substrate 1000 is increased by hardening so as to perform cutting by S300, and finally the moisture content of the extrusion substrate 1000 is reduced by S200 to obtain a finished aerosol generating substrate.

In a second embodiment, the aerosol generating substrate is obtained by S100, S300, and S200 in order. The difference between the second embodiment and the first embodiment lies in that the hardening step is removed, that is, the extrusion substrate 1000 extruded from the extrusion device 1 can be directly cut. For example, in the case where the length of the aerosol generating substrate in the longitudinal direction is short, the hardening step can be omitted if the slight deformation caused by the cutting has no effect on subsequent production.

In a third embodiment, the aerosol generating substrate is obtained by S100, S200, and S300 in order. The difference between the third embodiment and the second embodiment lies in that the sequence of the hot air drying step and the cutting step is exchanged. In this embodiment, the extrusion substrate 1000 extruded by S100 is first subjected to hot air drying in S200 and then is cut. The extrusion substrate 1000 may undergo volume shrinkage after hot air drying, and the consistency of longitudinal dimensions of aerosol generating substrates after cutting can be improved by hot air drying first and then cutting.

In a fourth embodiment, the aerosol generating substrate is obtained by S100 and S200 in order. The difference between fourth embodiment and the first embodiment lies in that the hardening step and the cutting step are removed, that is, the extrusion substrate 1000 is subjected to hot air drying to obtain a finished aerosol generating substrate. By way of example, the extrusion substrate 1000 is extruded in a vertical direction, and the extrusion substrate 1000 reaches a preset length (for example, the extrusion substrate 1000 reaches a critical value), the extrusion substrate 1000 will naturally detach (disconnect). The preset length of the extrusion substrate 1000 is the length required for the aerosol generating substrate. In this way, the hardening step and the cutting step can be eliminated, thereby reducing the subsequent processing process and reducing the production cost.

In one embodiment, the manufacturing method includes the following operation.

A wrapping layer is wrapped around an outer surface of the aerosol generating substrate.

Referring to FIGS. 2 to 4, the wrapping layer is wrapped around the outer surface of the aerosol generating substrate by a wrapping device 7, and the aerosol generating substrate can be protected by the wrapping layer.

The wrapping layer includes, but is not limited to, one of or a combination of some of fiber paper, metal foil, metal foil composite fiber paper, polyethylene composite fiber paper, PE (Polyethylene), and PBAT (Polybutylene Adipate Terephthalate).

In some embodiments, after the wrapping layer is wrapped around the outer surface of the aerosol generating substrate, the aerosol generating substrate may be combined with the functional segment, to form an aerosol generating article.

In other embodiments, the aerosol generating substrate may first be combined with the functional segment, and then a wrapping layer is wrapped around an outer surface of each of the aerosol generating substrate and the functional segment, to form an aerosol generating article.

In still other embodiments, a wrapping layer can be first wrapped around the outer surface of the aerosol generating substrate, then the aerosol generating substrate is combined with the functional segment and a wrapping layer is further applied, to form an aerosol generating article. That is, the outer surface of the aerosol generating substrate may be wrapped with multiple wrapping layers.

Referring to FIGS. 2 to 4, an embodiment of the present disclosure further provides an apparatus for manufacturing an aerosol generating substrate. The manufacturing apparatus includes an extrusion device 1 and a drying device 2.

The extrusion device 1 is configured for subjecting a material mixture to low temperature extrusion to form an extrusion substrate 1000.

The drying device 2 is configured for subjecting the extrusion substrate 1000 to hot air drying.

In the manufacturing apparatus provided by the embodiment of the present disclosure, the extrusion device 1 is configured for subjecting the material mixture to the low temperature extrusion, the viscosity of the material mixture is high, the extrusion substrate 1000 is more easily bonded tightly, the problems of loosening and cracking are not easy to occur, and the yield is effectively improved. In addition, the low temperature extrusion can offset the heat generated during the extrusion process of the material mixture, thereby reducing the loss of volatile aroma substances during the extrusion process. The drying device 2 uses hot air to dry the extrusion substrate 1000, and in the case of hot air drying, the shrinkage rate of the extrusion substrate 1000 is small, the drying time is short, and the continuous production can be facilitated. The combination of the low temperature extrusion and the hot air drying can achieve continuous production, with high production efficiency and low manufacturing cost; the extrusion substrate 1000 is uniform and stable, and has high processability.

In one embodiment, referring to FIGS. 2 to 4, the drying device 2 includes a casing 21, a fan 22 and a heating element 23. The casing 21 has a drying chamber 21a. The fan 22 is configured for driving air flow in the drying chamber 21a to flow. The heating element 23 is provided in the drying chamber 21a and is configured for heating the air flow in the drying chamber 21a. In this way, the heating element 23 generates heat to heat the air flow in the drying chamber 21a, and the fan 22 accelerates the flow of the air flow in the drying chamber 21a.

In one embodiment, referring to FIGS. 3 and 4, there are at least two heating elements 23, and the at least two heating elements 23 are spaced apart in the up-down direction to form a spacing for conveying the extrusion substrate 1000. That is, the extrusion substrate 1000 is conveyed in the spacing, and the at least two heating elements 23 are located on upper and lower sides of the extrusion substrate 1000. In this way, the at least two heating elements 23 simultaneously bake the extrusion substrate 1000 from above and below, so that the extrusion substrate 1000 can be heated evenly, the morphological stability of the extrusion substrate 1000 can be improved, the dewatering efficiency can be improved, and the load of a single heating element 23 can be reduced.

In some embodiments, only one heating element 23 may be provided, and when the heating efficiency of the heating element 23 is high, a good drying effect can be achieved.

The structural shape of the heating element 23 is not limited, and by way of example, referring to FIGS. 3 and 4, the heating element 23 has a plate-like structure. The heating element 23 may be in the form of a flat plate or a curved plate. The heating element 23 having a plate-like structure may be arranged in the horizontal direction. That is, the thickness direction of the heating element 23 having the plate-like structure is perpendicular to the horizontal direction.

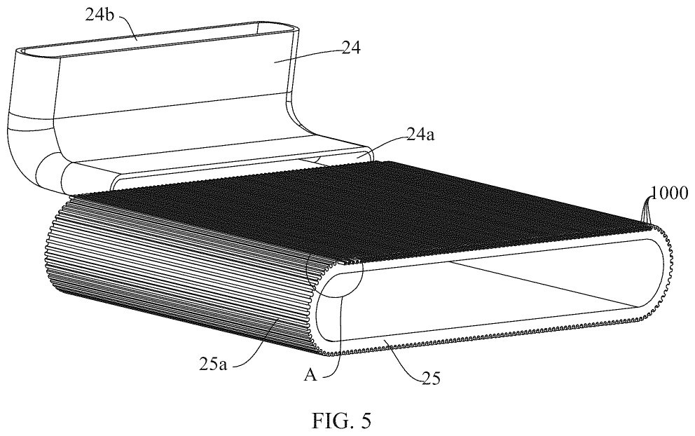

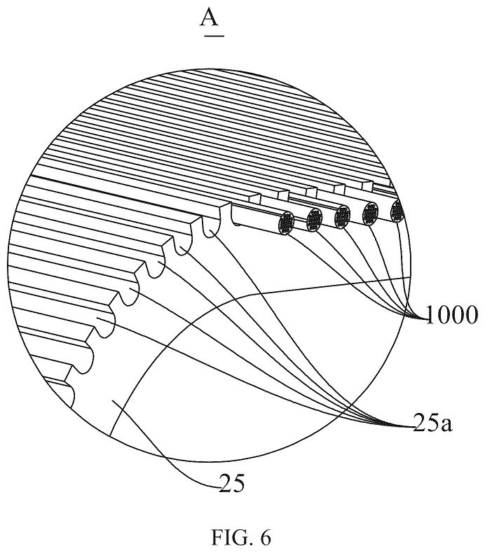

In one embodiment, referring to FIGS. 5 and 6, the drying device 2 comprises a conveyor belt 25 for conveying the extrusion substrate 1000, a surface of the conveyor belt 25 facing the extrusion substrate 1000 is formed with a plurality of grooves 25a, each groove 25a is configured for receiving one extrusion substrate 1000, at least a portion of the extrusion substrate 1000 is positioned within the groove 25a. The conveyor belt 25 is rotatable to drive a displacement of the extrusion substrate 1000. By way of example, the plurality of grooves 25a are arranged at intervals along a conveying direction of the conveyor belt 25, and a length direction of the groove 25a intersects the conveying direction. Both ends in the length direction of the groove 25a run through both ends in a width direction of the conveyor belt 25. On the one hand, a wall surface of the groove 25a may restrict movement of the extrusion substrate 1000 to avoid displacement of the extrusion substrate 1000 during conveyance. On the other hand, each of the grooves 25a is configured for receiving one extrusion substrate 1000, and the grooves 25a can prevent a plurality of extrusion substrates 1000 from contacting and adhering.

In one embodiment, the groove 25a is formed with a placement opening. The extrusion substrate 1000 is placed into the groove 25a through the placement opening.

By way of example, the cross-sectional shape of the groove 25a is not limited, and the cross-sectional shape of the groove 25a may be semi-circular, semi-elliptical, or the like.

In some embodiments, the drying device 2 may also include a clamp configured for clamping the extrusion substrate 1000 to secure the extrusion substrate 1000 on the conveyor belt 25. The clamp restricts movement of the extrusion substrate 1000 relative to the conveyor belt 25.

In one embodiment, referring to FIGS. 3 and 4, the casing 21 is formed with an inlet 21b and an outlet 21c both communicating with the drying chamber 21a, and a portion of the conveyor belt 25 is provided in the spacing between two heating elements 23. The conveyor belt 25 is configured to convey the extrusion substrate 1000 from the inlet 21b to the outlet 21c. The extrusion substrate 1000 is placed onto the conveyor belt 25 through the inlet 21b and is conveyed by the conveyor belt 25 to the outlet 21c. Continuous conveyance of the extrusion substrate 1000 can be achieved by the conveyor belt 25.

In one embodiment, referring to FIGS. 5, 6 and 8, the extrusion substrate 1000 has airways 1000a extending through at least one end of the extrusion substrate 1000 in the longitudinal direction, the drying device 2 includes a flow guide channel 24 for guiding the hot air, and an air outlet 24a of the flow guide channel 24 is located on a side of the extrusion substrate 1000 in the longitudinal direction. That is, the air outlet 24a of the flow guide channel 24 faces openings of the airways 1000a of the extrusion substrate 1000. In this way, the air flow blown from the air outlet 24a of the flow guide channel 24 can enter the airways 1000a through the openings of the airways 1000a. For example, in the hot air drying process, the flow direction of the hot air is parallel to the longitudinal direction of the extrusion substrate 1000. Thus, the contact area between the hot air and the extrusion substrate 1000 can be increased, and the drying efficiency can be improved.

By way of example, in one embodiment, referring to FIG. 5, the outlet 51c of the fan 22 is connected to the air inlet 24b of the flow guide channel 24 so that the air flow from the fan 22 can flow out of the air outlet 24a of the flow guide channel 24. The heating element 23 may be provided in the flow guide channel 24, or the heating element 23 may be provided in an enclosure of the fan 22.

It is to be understood that an air blowing direction of the air outlet 24a of the flow guide channel 24 may be inclined at a certain angle with respect to the longitudinal direction of the extrusion substrate 1000, so that the inner and outer surfaces of the extrusion substrate 1000 can be heated at the same time, which can improve the drying efficiency.

In one embodiment, referring to FIGS. 3 and 4, the manufacturing apparatus comprises a microwave device 3 located at least partially within the drying chamber 21a, and the microwave device 3 dries the extrusion substrate 1000 by emitting microwave radiation. Microwave radiation drying means that the polar molecules inside the extrusion substrate 1000 are violently vibrated by microwaves to generate heat to promote the volatilization of moisture in the extrusion substrate 1000, which can reduce the hot air drying temperature, reduce the drying time, and improve the retention rate of aroma components and effective substances in the aerosol generating substrate.

By way of example, in some embodiments, microwave irradiation drying may be employed prior to or simultaneously with hot air drying.

In one embodiment, referring to FIGS. 3 and 4, the manufacturing apparatus comprises an ultrasonic device 4 located at least partially within the drying chamber 21a, and the ultrasonic device 4 dries the extrusion substrate 1000 by emitting ultrasonic radiation. Ultrasonic radiation drying means that the moisture inside the extrusion substrate 1000 generates cavitation effect by ultrasonic waves, to reduce the moisture volatilization temperature, and promote moisture volatilization, thereby reducing the hot air drying temperature, reducing the drying time, and improving the retention rate of aroma components and effective substances in the aerosol generating substrate.

By way of example, in some embodiments, ultrasonic irradiation drying may be performed prior to or simultaneously with hot air drying.

In one embodiment, referring to FIGS. 3 and 4, a microwave device 3 may be provided above or below any heating element 23. In this way, the microwave device 3 emits a wider range of microwaves, such as electromagnetic waves, so that the extrusion substrate 1000 can be heated more uniformly.

In one embodiment, microwave devices 3 may be provided on both sides of the conveyor belt 25 in the width direction thereof. In this way, the microwave device 3 emits microwaves such as electromagnetic waves with less energy loss, so that the overall heating rate can be increased.

In one embodiment, referring to FIGS. 3 and 4, an ultrasonic device 4 may be disposed above or below any heating element 23. In this way, the ultrasonic device 4 emits a wider range of ultrasonic waves, so that the extrusion substrate 1000 can be heated more uniformly.

In one embodiment, ultrasonic devices 4 may be provided on both sides of the conveyor belt 25 in the width direction thereof. In this way, the ultrasonic device 4 emits ultrasonic waves with less energy loss, so that the overall heating rate can be improved.

In one embodiment, referring to FIGS. 2 to 4, the extrusion device 1 includes an extrusion cylinder 11, an extrusion screw 12, and a die opening 13. The extrusion cylinder 11 includes an extrusion cavity 11a for accommodating a material mixture and a discharge port 11c communicating with the extrusion cavity 11a. The extrusion screw 12 is rotatably disposed within the extrusion cavity 11a. The die opening 13 is provided at the discharge port 11c, and the extrusion screw 12 pushes the material mixture out of the die opening 13 to form the extrusion substrate 1000. The extrusion cylinder 11 is formed with a feed port 11b communicating with the extrusion cavity 11a. The extrusion screw 12 is configured to push the material mixture toward the discharge port 11c. By way of example, during rotation of the extrusion screw 12, the material mixture can flow along a threaded channel in the circumferential surface of the extrusion screw 12 toward the discharge port 11c. The die opening 13 is configured for forming an extrusion substrate 1000 having a set cross-sectional shape.

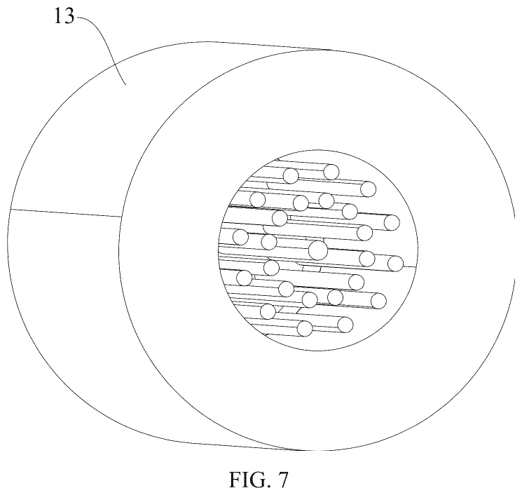

In one embodiment, referring to FIGS. 3, 4 and 7 to 9, the extrusion device 1 includes a die base 15, and the die opening 13 is disposed on the die base 15. The die base 15 provides a mounting position for the die opening 13.

In one embodiment, the die base 15 closes the discharge port 11c. In this way, the material mixture is extruded through the die opening 13.

In one embodiment, one die opening 13 is provided on a single die base 15. That is to say, a single-base single-opening is adopted. In this way, the size of the extrusion screw 12 may be small.

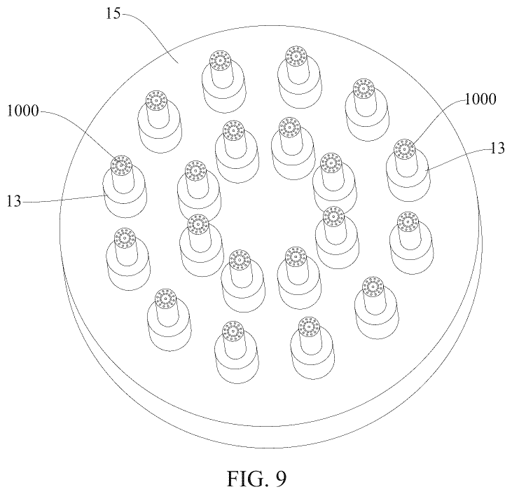

In one embodiment, referring to FIG. 9, a plurality of die openings 13 are provided on a single die base 15. That is, a single-base multi-opening is adopted. After the material mixture passes through the plurality of die openings 13, a plurality of extrusion substrates 1000 are simultaneously formed. Thus, the production efficiency can be improved and mass production can be achieved.

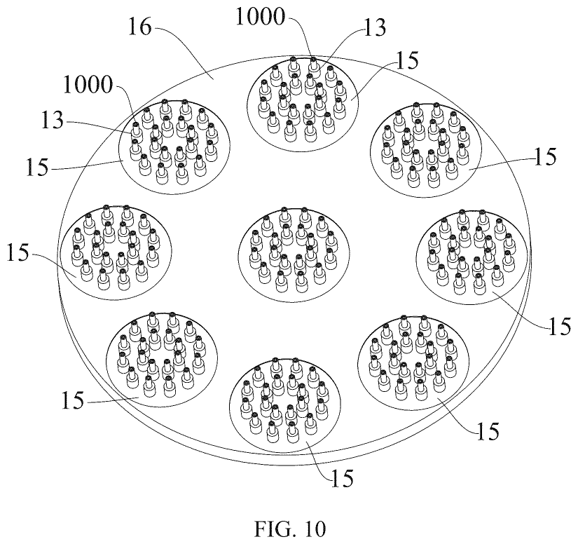

In one embodiment, referring to FIG. 10, there are a plurality of die bases 15, the extrusion device 1 includes an adapter 16, the plurality of die bases 15 are provided on the adapter 16, and the adapter 16 closes the discharge port 11c. That is to say, multi-base multi-opening is adopted. The multi-base multi-opening allows for installation of more die openings 13 than the single-base multi-opening, thereby forming more extrusion substrates 1000 at the same time. In this way, the production efficiency can be improved, and this is more suitable for mass production.

In one embodiment, referring to FIGS. 2 to 4, the manufacturing apparatus comprises a hardening device 5 for cooling and hardening the extrusion substrate 1000.

In one embodiment, referring to FIGS. 3, 4 and 11, the hardening device 5 includes a housing 51 and a conveyor belt 52. The housing 51 is formed with an inlet 51a, a cold chamber 51b and an outlet 51c. The inlet 51a and the outlet 51c each communicate with the cold chamber 51b. At least part of the conveyor belt 52 is located within the cold chamber 51b, and the conveyor belt 52 is configured for conveying the extrusion substrate 1000 from the inlet 51a to the outlet 51c. The extrusion substrate 1000 is placed onto the conveyor belt 52 through the inlet 51a and conveyed by the conveyor belt 52 to the outlet 51c. The extrusion substrate 1000 can be continuously conveyed by the conveyor belt 52, so that the extrusion substrate 1000 can be continuously hardened by the hardening device 5 to achieve continuous generation.

In one embodiment, referring to FIGS. 3, 4, and 11, the housing 51 is formed with an injection opening 51d that communicates with the cold chamber 51b to inject a refrigerant into the cold chamber 51b. The refrigerant can contact the extrusion substrate 1000 to absorb the heat of the extrusion substrate 1000, thereby cooling and hardening the extrusion substrate 1000. In this way, the outer surface of the extrusion substrate 1000 can be rapidly cooled and hardened, so that the stability of the morphology of the extrusion substrate 1000 can be maintained, continuous production can be facilitated, and production efficiency can be improved.

The refrigerant may be liquid, gaseous, or solid. By way of example, the refrigerant includes, but is not limited to, liquid nitrogen, liquid air, and the like.

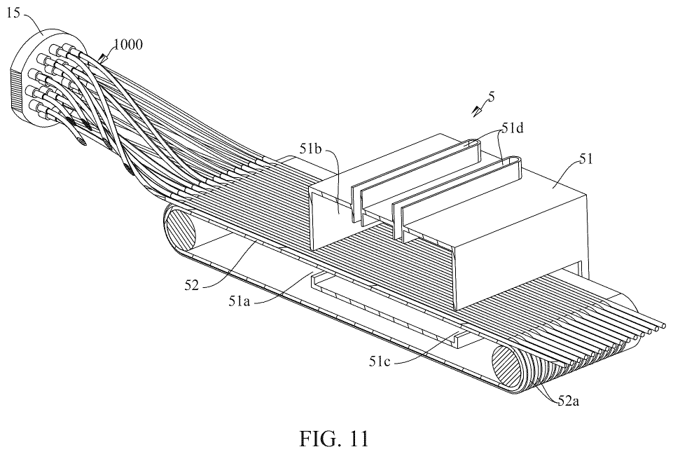

By way of example, in one embodiment, referring to FIG. 11, the injection opening 51d extends in a direction intersecting a conveying direction of the conveyor belt 52.

In one embodiment, referring to FIG. 11, the injection opening 51d may be formed on an upper surface of the housing 51. In this way, the refrigerant can enter the cold chamber 51b from top to bottom to contact the extrusion substrate 1000 located on the conveyor belt 52.

In one embodiment, referring to FIG. 11, a surface of the conveyor belt 52 facing the extrusion substrate 1000 is formed with a plurality of guide grooves 52a, each guide groove 52a is configured for receiving one extrusion substrate 1000, and at least a portion of the extrusion substrate 1000 is positioned within the guide groove 52a. On the one hand, the wall surface of the guide groove 52a may restrict movement of the extrusion substrate 1000 to avoid displacement of the extrusion substrate 1000 during conveyance. On the other hand, each guide groove 52a is configured for receiving one extrusion substrate 1000, and the guide groove 52a can prevent a plurality of extrusion substrate 1000 from contacting and sticking.

By way of example, in one embodiment, referring to FIG. 11, the length direction of the guide groove 52a is the same as the conveying direction of the conveyor belt 52. The plurality of guide grooves 52a are arranged at intervals in the width direction of the conveyor belt 52.

In one embodiment, the guide groove 52a is formed with a depositing opening. The extrusion substrate 1000 is deposited into the guide groove 52a through the depositing opening.

By way of example, the cross-sectional shape of the guide groove 52a is not limited, and the cross-sectional shape of the guide groove 52a may be semi-circular, or semi-elliptical.

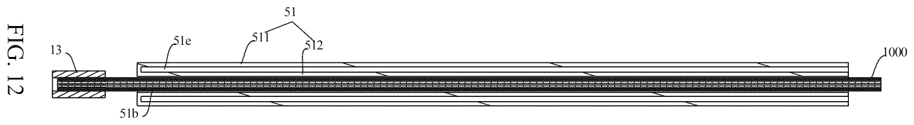

In one embodiment, referring to FIG. 12, the housing 51 is formed with a refrigerant channel 51e, the cold chamber 51b and the refrigerant channel 51e are isolated from each other, the cold chamber is located in the refrigerant channel 51e, and the extrusion substrate 1000 is in contact with the wall surface of the cold chamber 51b. That is, the refrigerant is not in contact with the extrusion substrate 1000. The refrigerant flows in the refrigerant channel 51e, and heat is transferred between the extrusion substrate 1000 and the refrigerant through the wall surface of the cold chamber 51b. This can avoid the problems of expansion, deformation and cracking of the extrusion substrate 1000 after rapid cooling caused by direct contact of the extrusion substrate 1000 with the refrigerant.

In one embodiment, referring to FIG. 12, the housing 51 includes an outer shell 511 and an inner shell 512 in which a cold chamber 51b is formed, the inner shell 512 is positioned inside the outer shell 511, and the inner shell and the outer shell collectively define a refrigerant channel 51e. The housing 51 has a double shell structure, the refrigerant channel 51e defined by the outer shell 511 and the inner shell 512 is configure for flow of the refrigerant, the cold chamber 51b and the refrigerant channel 51e are isolated by the inner shell 512, and the extrusion substrate 1000 is in contact with the inner surface of the inner shell 512 to transfer heat to the refrigerant through the inner shell 512.

In one embodiment, the smoothness of the wall surface of the cold chamber 51b ranges from Ra 1.2 μm to Ra 0.08 μm. Ra refers to the average surface roughness value, which is used to indicate the finish and roughness of a surface. By way of example, the smoothness of the wall surface of the cold chamber 51b is Ra 1.2 μm, Ra 1.1 μm, Ra 1.0 μm, Ra 0.5 μm, Ra 0.3 μm, Ra 0.1 μm or Ra 0.08 μm. The wall surface of the cold chamber 51b is a smooth surface, and the friction force between the wall surface of the cold chamber 51b and the outer surface of the extrusion substrate 1000 is very small, which will not cause deformation of the extrusion substrate 1000.

In one embodiment, the hardening device 5 includes a refrigerant supplier connected to the injection opening 51d or connected to the refrigerant channel 51e. That is, the refrigerant supplier is configured for injecting the refrigerant into the injection opening 51d. Alternatively, the refrigerant supplier is configured for injecting refrigerant into the refrigerant channel 51e.

In one embodiment, referring to FIGS. 3 and 4, the manufacturing apparatus includes a cutting device 6 having a cutting tool 61. The cutting tool cuts the extrusion substrate 1000 by physical contact or non-physical contact.

Physical contact refers to that the extrusion substrate 1000 is cut by the direct contact of the cutting tool 61 with the extrusion substrate 1000. For example, the cutting tool 61 may be a rotary hob, a cutting blade, a cutting line, a roller cutter, or an extrusion.

The non-physical contact refers to that the cutting tool 61 does not need to be in direct contact with the extrusion substrate 1000 to cut the extrusion substrate 1000. For example, the cutting tool 61 releases a laser, plasma, air knife, or water jet by which the extrusion substrate 1000 is cut.

The manufacturing apparatus employed in the embodiments of the present disclosure can be used in the manufacturing method of the embodiments of the present disclosure, and the description of embodiments of the manufacturing apparatus is similar to the description of any one of embodiments of the manufacturing method, and has the same beneficial effects as the embodiments of the manufacturing method. For the technical details not disclosed in the manufacturing method in the embodiments of the present disclosure, please refer to the description of the embodiments of the extrusion device 1, the drying device 2, the hardening device 5, and the cutting device 6 of the embodiments of the present disclosure.

In the description of the present disclosure, descriptions with reference to the terms “in one embodiment”, “in some embodiments”, “in other embodiments”, “in still other embodiments” or “by way of example” mean that specific features, structures, materials, or characteristics described in connection with the embodiments or examples are included in at least one embodiment or example of the embodiments of the present disclosure. In the present disclosure, the schematic expression of the above terms is not necessarily directed to the same embodiment or example. Moreover, the specific features, structures, materials, or characteristics described may be combined in any one or more embodiments or examples in a suitable manner. Furthermore, those skilled in the art can combine different embodiments or examples described in the present disclosure and features of different embodiments or examples without contradicting each other.

The above description merely involves preferred embodiments of the present disclosure, and is not intended to limit the present disclosure, and various modifications and variations may be made to those skilled in the art. Any modification, equivalent substitution, and improvement, etc. made within the spirit and principle of the present disclosure are included within the scope of protection of the present disclosure.

1. A method for manufacturing an aerosol generating substrate, comprising:
subjecting a material mixture to low temperature extrusion to form an extrusion substrate; and
subjecting the extrusion substrate to hot air drying.

2. The method according to claim 1, wherein an extrusion temperature for the low temperature extrusion is greater than or equal to −50° C. and less than 10° C.

3. The method according to claim 2, wherein the extrusion temperature for the low temperature extrusion ranges from −35° C. to 5° C.

4. The method according to claim 1, wherein an extrusion pressure for the low temperature extrusion ranges from 0.5 bar to 300 bar.

5. The method according to claim 1, wherein a temperature for the hot air drying ranges from 50° C. to 200° C.

6. The method according to claim 5, wherein the temperature for the hot air drying ranges from 75° C. to 125° C.

7. The method according to claim 1, wherein a moisture content of the extrusion substrate after drying ranges from 3% to 20%.

8. The method according to claim 1, wherein the extrusion substrate has airways extending through at least one end of the extrusion substrate in a longitudinal direction, and wherein a flow direction of hot air is parallel to the longitudinal direction of the extrusion substrate during the hot air drying.

9. The method according to claim 1, wherein the method, after subjecting the material mixture to the low temperature extrusion to form the extrusion substrate, comprises:
cutting the extrusion substrate.

10. The method according to claim 1, wherein the method, before subjecting the extrusion substrate to the hot air drying, comprises:
hardening the extrusion substrate by cooling.

11. The method according to claim 10, wherein a hardness of the extrusion substrate after hardening ranges from 1 HB to 200 HB.

12. The method according to claim 1, wherein the extrusion substrate is extruded in a horizontal direction; or,
the extrusion substrate is extruded in a vertical direction; or,
the extrusion substrate is extruded in an inclined direction.

13. The method according to claim 1, wherein the material mixture comprises, in parts by weight, 30 to 90 parts of plant raw materials, 1 to 15 parts of auxiliary raw materials, 5 to 30 parts of smoking agent raw materials, 1 to 10 parts of binder raw materials, and 1 to 15 parts of perfume raw materials.

14. An apparatus for manufacturing an aerosol generating substrate, comprising:
an extrusion device configured for subjecting a material mixture to low temperature extrusion to form an extrusion substrate; and
a drying device configured for subjecting the extrusion substrate to hot air drying.

15. The apparatus according to claim 14, wherein the drying device comprises:
a casing having a drying chamber;
a fan configured for driving air flow in the drying chamber to flow; and
a heating element arranged in the drying chamber, and configured for heating the air flow in the drying chamber.

16. The apparatus according to claim 14, wherein the drying device comprises:
a casing having a drying chamber;
a fan configured for driving air flow in the drying chamber to flow; and
at least two heating elements arranged in the drying chamber, and configured for heating the air flow in the drying chamber, and the at least two heating elements are spaced apart in an up-down direction to form a spacing for conveying the extrusion substrate.

17. The apparatus according to claim 14, wherein the extrusion substrate has airways extending through at least one end of the extrusion substrate in a longitudinal direction, and the drying device comprises a flow guide channel for guiding hot air, the flow guide channel having an air outlet located on a side of the extrusion substrate in the longitudinal direction.

18. The apparatus according to claim 14, wherein the drying device comprises a conveyor belt for conveying the extrusion substrate, a surface of the conveyor belt facing the extrusion substrate is formed with a plurality of grooves, each of the grooves is configured for receiving one extrusion substrate, and at least a portion of the extrusion substrate is positioned within a respective one of the grooves.

19. The apparatus according to claim 15, comprising: at least one of a microwave device or an ultrasonic device,
wherein the microwave device is located at least partially within the drying chamber, and is configured for drying the extrusion substrate by emitting microwave radiation; and
wherein the ultrasonic device is located at least partially within the drying chamber, and is configured for drying the extrusion substrate by emitting ultrasonic radiation.
